(19) United States
(12) Patent Application Publication
(10) Pub. No.: US 2022/0170805 A1
(43) Pub. Date: Jun. 2, 2022

(54) FORCE SENSING DEVICE AND ELECTRONIC DEVICE INCLUDING FORCE SENSING DEVICE

(71) Applicant: SAMSUNG ELECTRO-MECHANICS CO., LTD., Suwon-si (KR)

(72) Inventors: Jong Man KIM, Suwon-si (KR); Se Yeon HWANG, Suwon-si (KR); Kyung Ho LEE, Suwon-si (KR); Seok Hwan KIM, Suwon-si (KR); Chul Kyu KIM, Suwon-si (KR); Han KIM, Suwon-si (KR)

(73) Assignee: SAMSUNG ELECTRO-MECHANICS CO., LTD., Suwon-si (KR)

(21) Appl. No.: 17/217,325

(22) Filed: Mar. 30, 2021

(30) Foreign Application Priority Data
Dec. 2, 2020 (KR) 10-2020-0166563

(51) Int. Cl. G01L 5/164; G01L 5/166

(52) U.S. Cl. CPC G01L 5/164; G01L 5/166

(57) ABSTRACT

A force sensing device includes a support member including: a sensor support portion to which a force sensor is coupled on one surface of the support member; and a frame coupling portion extending from the sensor support portion. The force sensing device further includes: a frame disposed to face another surface of the support member, and disposed to be spaced apart from the support member; and at least one spacing member disposed between the support member and the frame, and spacing the support member apart from the frame. The force sensor is not disposed in the frame coupling portion. The spacing member is disposed between the frame coupling portion and the frame.

### CROSS-REFERENCE TO RELATED APPLICATIONS

This application claims the benefit under 35 U.S.C. § 119(a) of Korean Patent Application No. 10-2020-0166563 filed on Dec. 2, 2020 in the Korean Intellectual Property Office, the entire disclosure of which is incorporated herein by reference for all purposes.

### BACKGROUND

### 1. Field

The following description relates to a force sensing device and an electronic device including a force sensing device.

### 2. Description of Related Art

Portable terminal devices such as laptop PCs, smartphones, smartpads, and the like, may include a display configured to provide information to a user, and an input means.

In conventional portable terminal devices, a mechanical switch is commonly used as an input means. In the case of such a mechanical switch, a large amount of space may be required internally to implement a function of the switch, and the switch has a shape protruding to the outside of the portable terminal device or a structure not integrated with an external case of the portable terminal device. Accordingly, there may be a limitation with respect to a design of the portable terminal device. In addition, there is a disadvantage that it may not be easy to dustproof or waterproof the portable terminal device due to the structure of the mechanical switch.

Therefore, a force sensing device may be implemented as an input means, instead of a conventional mechanical switch, to improve the design and performance, such as waterproofing and dustproofing, of a portable terminal device.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a force sensing device includes a support member including: a sensor support portion to which a force sensor is coupled on one surface of the support member; and a frame coupling portion extending from the sensor support portion. The force sensing device further includes: a frame facing another surface of the support member, and disposed to be spaced apart from the support member; and at least one spacing member disposed between the support member and the frame, and spacing the support member apart from the frame. The force sensor is not disposed in the frame coupling portion. The spacing member is disposed between the frame coupling portion and the frame.

The at least one spacing member may have a spherical shape or a cylindrical shape.

The frame may include at least one insertion portion disposed on one surface of the frame. The at least one spacing member may be disposed in the at least one insertion portion.

The at least one insertion portion may be formed as a concave groove having an inner radius of curvature that is greater than a radius of curvature of a surface of the at least one spacing member.

The frame may include at least one protruding portion protruding from another surface of the frame in a region corresponding to the at least one insertion portion.

The support member may include at least one insertion portion disposed on another surface of the support member. The at least one spacing member may be disposed in the at least one insertion portion.

The at least one insertion portion may include a concave groove having an inner radius of curvature that is greater than a radius of curvature of a surface of the at least one spacing member.

The frame coupling portion may include at least one protruding portion protruding from the one surface of the frame in a region corresponding to the at least one insertion portion.

The at least one spacing member may include a plurality of spacing members disposed on a straight line.

The at least one spacing member may be disposed to contact the support member on a center line bisecting the support member along a length direction of the support member.

The spacing member may be in point-contact or line-contact with the support member and the frame.

The force sensing device may further include a pressing member disposed between the sensor support portion and the frame, and configured to press the sensor support portion.

The pressing member and the support member may be in contact with each other in a portion disposed on a same plane as a portion in which the at least one spacing member contacts the support member.

A spacing distance between the sensor support portion and the frame may be different from a spacing distance between the frame coupling portion and the frame.

The pressing member may protrude from the frame in a cantilever form.

A surface of the pressing member that is in contact with the sensor support portion may be a curved surface.

In another general aspect, an electronic device includes: an accommodation member including a first sidewall and a second sidewall, the second sidewall being disposed opposite the first sidewall and configured to be deformed by external force; and a force sensing device disposed in the accommodation member. The force sensing member includes: a frame disposed in contact with a first sidewall; a support member spaced apart from the frame, at least a portion of the support member being in contact with the second sidewall; at least one force sensor coupled to the support member and opposing the second sidewall; and a plurality of spacing members disposed between the support member and the frame, and disposed in contact with the support member on a center line bisecting the support member in a length direction of the support member.

The plurality of spacing members may be disposed between a central portion of the support member, with respect to the length direction, and the frame. The force sensor may be coupled to an end portion of the support member, with respect to the length direction.

The electronic device may further include a plurality of pressing members extending from the frame and configured to press the support member to the second sidewall. The plurality of pressing members may be in contact with the support member on the center line.

In another general aspect, a force sensing device includes: a support member including a sensor support portion disposed in outer an outer portion of the support member, with respect to a length direction of the support member; a force sensor mounted on a first surface of the support member, in the sensor support portion; a frame opposing a second surface of the support member; and a plurality of spacing members disposed between the frame and a central portion of the support member, with respect to the length direction, and spacing the support member and the frame apart from each other.

The plurality of spacing members may have a spherical shape or a cylindrical shape, and may be in contact with the support member on a center line that bisects the support member in the length direction.

The force sensing device may further include a plurality of spring members extending from the frame and configured to press the support member. The plurality of spring members may be in contact with the support member on the center line.

Other features and aspects will be apparent from the following detailed description, the drawings, and the claims.

### BRIEF DESCRIPTION OF DRAWINGS

FIG. 1 is a perspective view of a force sensing device, according to an embodiment.

FIG. 2 is an exploded perspective view of the force sensing device shown in FIG. 1.

FIG. 3 is a plan view of the force sensing device illustrated in FIG. 1.

FIG. 4 is a cross-sectional view taken along line I-I′ of FIG. 3.

FIG. 5 is a partial cross-sectional view illustrating an enlarged portion A of FIG. 3.

FIG. 6 is a perspective view of FIG. 5.

FIG. 7 is an exploded perspective view of FIG. 6.

FIGS. 8 and 9 are cross-sectional views of an electronic device in which the force sensing device shown in FIG. 1 is mounted, according to an embodiment.

FIG. 10 is an exploded perspective view illustrating a force sensing device, according to another embodiment.

FIG. 11 is a cross-sectional view of the force sensing device shown in FIG. 10.

FIG. 12 is an exploded perspective view illustrating a force sensing device, according to another embodiment.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure. Hereinafter, while embodiments of the present disclosure will be described in detail with reference to the accompanying drawings, it is noted that examples are not limited to the same.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. As used herein “portion” of an element may include the whole element or less than the whole element.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may be also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of this disclosure. Further, although the examples described herein have a variety of configurations, other configurations are possible as will be apparent after an understanding of this disclosure.

Herein, it is noted that use of the term “may” with respect to an example, for example, as to what an example may include or implement, means that at least one example exists in which such a feature is included or implemented while all examples are not limited thereto.

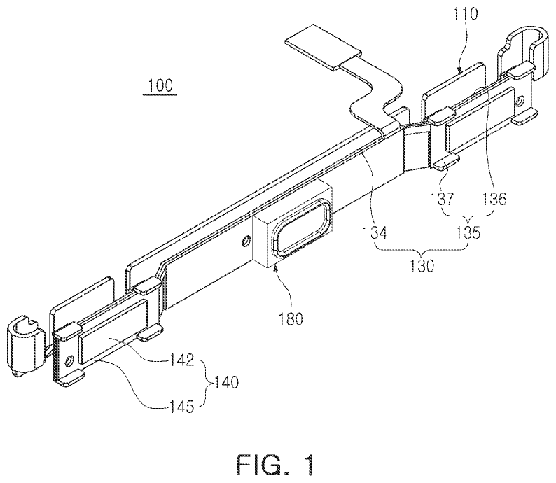

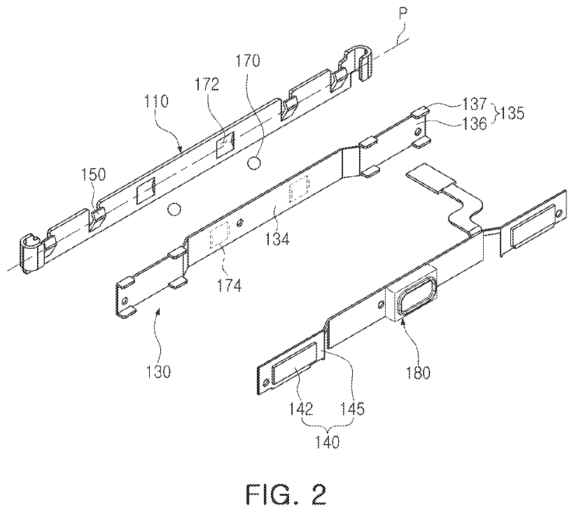

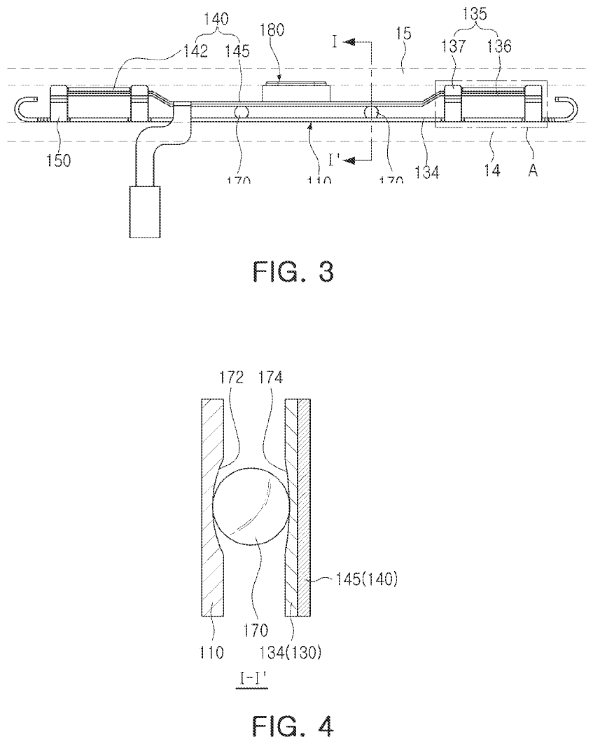

FIG. 1 is a perspective view illustrating a force sensing device 100, according to an embodiment. FIG. 2 is an exploded perspective view illustrating the force sensing device 100. FIG. 3 is a plan view illustrating the force sensing device 100. FIG. 4 is a cross-sectional view taken along line I-I′ of FIG. 3.

Referring to FIGS. 1 to 4, the force sensing device 100 may include, for example, a sensor portion 140, a support member 130, a frame 110, a pressing member 150, and a spacing member 170.

The senor portion 140 may include at least one force sensor 142 and may include a connection portion 145 electrically connecting an electronic device on which the force sensing device 100 is mounted to the force sensor 142.

A circuit board such as an FPCB or a PCB may be used as the connection portion 145.

A plurality of force sensors 142 may be disposed to be spaced apart from one another and may be mounted on a first surface of the connection portion 145.

The force sensor 142 may include a sensing coil. For example, the force sensor 142 may be a sensor configured to detect a change in distance between the sensing coil and a displacement object (e.g., a case of an electronic device on which the force sensing device is mounted).

A shape of the sensing coil is not limited to any particular shape, and a coil pattern of the sensing coil may be formed in various shapes such as a circular shape, a rectangular shape, or the like. In addition, the sensing coil may also be in the form of a wiring pattern in a PCB or a FPCB, or may be in the form of a chip inductor.

The force sensor 142 may sense changes in a shape of a displacement object by force applied to the displacement object. For example, when a user presses a surface (hereinafter, a pressed surface) of a case, the pressed surface may be bent, and accordingly, a distance between the sensing coil, which is used for resonance, and the pressed surface, which is a displacement object, may change.

Due to the changes in the distance between the sensing coil and the pressed surface, a magnitude of an eddy current generated on a side of the pressed surface may change and, accordingly, there may be a change in inductance of the sensing coil. Accordingly, the force sensing device 100 may sense changes in pressing of the surface of the case based on the change in inductance, and may recognize the change as an input signal.

The support member 130 is formed in a generally flat plate shape, and may include a frame coupling portion 134 coupled to the frame 110 via a spacing member 170, which will be described in more detail later, and a sensor support portion 135 disposed to be spaced apart from the frame 110 by a certain distance.

At least one portion of the support member 130 may be formed to be curved and bent at a curved portion. The frame coupling portion 134 and the sensor support portion 135 may be distinguished from each other by the curved portion.

Due to the above-described curved portion, a spacing distance from the frame coupling portion 134 to the frame 110 may be different from a spacing distance from the sensor support portion 135 to the frame 110.

The frame coupling portion 134 extends from the sensor support portion 135 and is coupled to a first surface of the frame 110. Accordingly, one surface of the frame coupling portion 134 may be coupled to the connection portion 145, and another, opposite surface of the frame coupling portion 134 may be coupled to the first surface of the frame 110.

The frame coupling portion 134 may be formed to have a width similar to that of the frame 110, or may be coupled to the frame 110 via the spacing member 170.

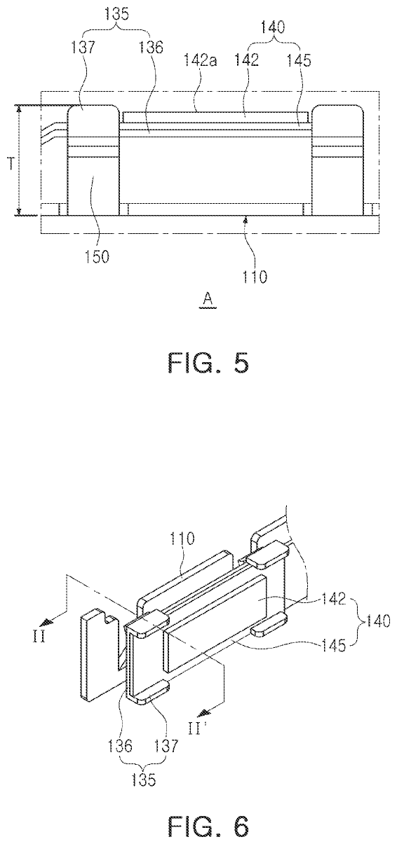

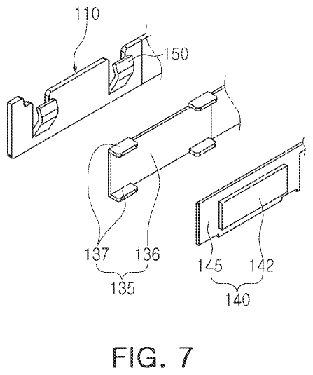

FIG. 5 is a partial cross-sectional view illustrating an enlarged portion A of FIG. 3. FIG. 6 is a perspective view of FIG. 5. FIG. 7 is an exploded perspective view of FIG. 6.

Referring to FIGS. 5 to 7 together, the sensor support portion 135 is coupled to the sensor portion 140 to separate the force sensor 142 of the sensor portion 140 from the displacement object by a certain distance. To this end, the sensor support portion 135 may include a support plate 136 and a support protrusion 137.

The support plate 136 may be formed in a flat plate shape and, for example, may be a metal plate.

The support plate 136 may be disposed on a second surface of the connection portion 145 to be coupled to the connection portion 145. An adhesive member may be interposed between the support plate 136 and the connection portion 145 for stable coupling.

In addition, the support plate 136 may be disposed to oppose the frame 110, which will be described in more detail later. For example, the support plate 136 may be disposed side-by-side with the connection portion 145 and the frame 110, between the connection portion 145 and the frame 110.

The force sensor 142 is disposed in the connection portion 145. Accordingly, the sensor support portion 135 may be disposed to oppose the force sensor 142 with the connection portion 145 interposed therebetween.

The sensor support portion 135 is formed to have a larger area than the force sensor 142. The area of the sensor support portion 135 may be determined in consideration of the size of the pressing member 150, which will be described in more detail later. For example, the force sensing device may be configured such that the pressing member 150 contacts the sensor support portion 135. In this case, the pressing member 150 may contact a region of the sensor support portion 135 disposed on outside of (e.g., does not oppose) the force sensor 142, rather than a region opposing the force sensor 142. Accordingly, a portion of the sensor support portion 135 disposed outside of the force sensor 142 may be formed to have a size in which the portion may be stably in contact with and pressed by the pressing member 150.

The region opposing the force sensor 142 may be a region in which, when an area occupied by the force sensor 142 is projected on one surface of the sensor support portion 135, the projected area occupied by the force sensor 142 may overlap the sensor support portion 135. Accordingly, the portion of the sensor support portion 135 disposed outside of the force sensor 142 may be a region in which the projected area occupied by the force sensor 142 does not overlap with the sensor support portion 135.

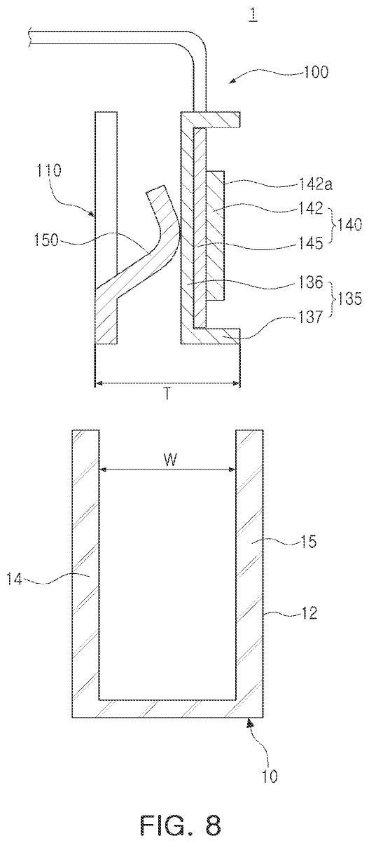

A plurality of support protrusions 137 are disposed between the sensor support portion 135 and a second sidewall 15 (shown in FIG. 8) to allow a sensing surface 142a of the force sensor to be spaced apart from the second sidewall 15 by a certain distance.

The plurality of support protrusions 137 may protrude from the support plate 136 in a direction orthogonal to the support plate 136. The sensor portion 140 is coupled to one surface of the sensor support portion 135. Accordingly, the support protrusion 137 may be disposed to protrude from an edge of the sensor support portion 135 so as not to interfere with the connection portion 145.

The plurality of support protrusions 137 may be disposed to be spaced apart from each other around the connection portion 145 and, accordingly, the connection portion 145 may be disposed in an internal region bounded by the support protrusions 137. In addition, the support protrusions 137 may be disposed in positions in which the support protrusions 137 are line-symmetrical or point-symmetrical to each other with respect to a center of the force sensor 142.

The support protrusions 137 are provided to prevent the force sensor 142 from being in contact with a displacement object by allowing the displacement object to be spaced apart from the force sensor 142. Accordingly, the support protrusions 137 may protrude to have a thickness greater than a thickness of the sensor portion 140 in a portion in which the force sensor 142 is disposed.

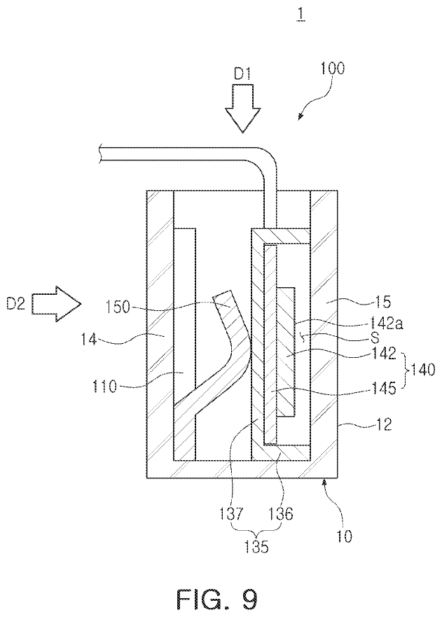

FIGS. 8 and 9 are cross-sectional views of an electronic device 1 in which the force sensing device 100 is mounted. FIG. 8 shows a cross-section of the electronic device 1 before the force sensing device 100 is coupled to the electronic device 1. FIG. 9 shows a cross-section of the electronic device 1 when the force sensing device is coupled to the electronic device.

For convenience of explanation, only an accommodation member 10, in which the force sensing device 100 is accommodated, is illustrated in the electronic device 1. In addition, the force sensing device 100 shows a cross-section taken along line II-II′ of FIG. 1.

The accommodation member 10 has an accommodation space in which the force sensing device 100 is accommodated, and the accommodation space includes a first sidewall 14, and a second sidewall 15 disposed to oppose the first sidewall 14. Here, the second sidewall 15 may be a portion deformable by external force, that is, a user's force, and may be, for example, a portion of a case of the electronic device 1. That is, the second sidewall 15 may be a displacement member.

When the force sensing device 100 is inserted into the accommodation member 10, the sensor support portion 135, to which the sensor portion 140 is coupled, is pressed to the second sidewall 15 side by the pressing member 150. In this case, the force sensor 142 is spaced apart from the second sidewall 15 by a certain distance by the support protrusion 137.

As shown in FIGS. 6 and 8, the support protrusion 137 may protrude to have a thickness greater than a thickness of the sensor portion 140. Accordingly, as shown in FIG. 9, when an end of the support protrusion 137 is in contact with the second sidewall 15, an empty space S may be secured between the force sensor 142 and the second sidewall 15. Accordingly, a sensing surface 142a of the force sensor 142 may be prevented from being directly in contact with the second sidewall 15.

The support protrusions 137 may be formed to protrude from four corner portions of the support plate 136, which may be formed of a plate-shaped member having a rectangular shape. As described above, when the support protrusions 137 support the second sidewall 15 at each corner portion of the force sensor 142, a spacing distance between the entire sensing surface 142a of the force sensor 142 and the second sidewall 15 may be maintained to be the same. Accordingly, an issue in which the force sensor 142 is inclined (.e.g., not oriented to extend parallel to the second sidewall 15) while disposed in the accommodation member 10, and the like, may be prevented.

The frame 110 may be formed of a flat plate-shaped member, and may include a first surface and a second surface opposing the first surface.

The support member 130 may be disposed on the first surface of the frame 110. The frame 110 may be spaced apart from the support member 130 by a certain distance, and the pressing member 150 and the spacing member 170 to be described later may be disposed between the frame 110 and the support member 130.

The pressing member 150 may be disposed to support the sensor support portion 135 of the support member 130, and may be elastically deformed. Accordingly, when external force is applied to the pressing member 150, the spacing distance between the frame 110 and the sensor support portion 135 may be changed.

The frame 110 may be formed of a metal material, but is not limited thereto.

As described above, the force sensing device 100 may be inserted into and disposed in the accommodation member 10 in a direction D1, as illustrated in FIG. 9. In this case, sensing efficiency of the force sensor 142 may degrade when a distance between the force sensor 142 and a pressing surface 12 of the second sidewall 15 is not maintained to be constant by an assembly tolerance and a manufacturing tolerance.

Accordingly, in the force sensing device 100, a spacing distance between the force sensor 142 and the second sidewall 15 of the accommodation member 10 may need to be maintained to be constant. To this end, the force sensing device 100 may include the pressing member 150.

The pressing member 150 may be disposed to protrude to the first surface side of the frame 110 and may press the sensor support portion 135 in which the force sensor 142 is disposed. Accordingly, the sensor support portion 135 may be pressed in the direction D2, as illustrated in FIG. 9, such that a state in which the support protrusion 137 is in close contact with the second sidewall 15 of the accommodation member 10 may be maintained.

Referring to FIG. 8, a width W of the internal space of the accommodation member 10 may be configured to be slightly less than a maximum thickness T (in FIG. 8) of the force sensing device 100, such that a state in which the sensor support portion 135 is in close contact with the second sidewall 15 may be maintained.

Accordingly, in the force sensing device 100, the pressing member 150 may be inserted into and disposed in the internal space of the accommodation member 10 in a state in which the pressing member 150 is elastically deformed, and a state in which the sensor support portion 135 is in close contact with the second sidewall 15 by recovery force of the pressing member 150 may be maintained.

The width W of the internal space of the accommodation member 10 may refer to a shortest distance between the first sidewall 14 and the second sidewall 15. In addition, a thickness T of the force sensing device 100 may refer to a shortest distance between an external surface of the frame 110 (e.g., the second surface of the frame 110) and an external end (free end) of the support protrusion 137.

In the frame 110, the pressing member 150 may be formed by partially cutting the frame 110 along a shape of the pressing member 150. Accordingly, the pressing member 150 may be formed as a portion protruding to the sensor portion 140 side by bending a portion of the cut out portion of the frame 110.

Accordingly, one side of the pressing member 150 may be formed as a plate spring shape or a cantilever spring shape fastened to the frame 110 and may be integrally formed with the frame 110. In addition, one end of the pressing member 150 may be connected to the frame 110, and the other end thereof may be spaced apart from a plane formed by the frame (e.g., a plane in which the first surface of the frame is formed) by a certain distance.

However, the pressing member 150 is not limited to the foregoing example, and, if desired, the pressing member 150 may be provided as a separate member, and may be attached to a first surface of the frame 110 or may be inserted into and coupled to the frame 110.

Referring to FIGS. 7 and 8, a portion of the pressing member 150 in contact with the sensor support portion 135 may be formed to have a curved surface, and may be configured to be in line-contact with the sensor support portion 135. Accordingly, friction force with the sensor support portion 135 may be minimized. However, the pressing member 150 is not limited to such a configuration, and various modifications are possible such as configuring that at least one protrusion may be disposed on the contact surface such that the pressing member 150 may be in point-contact with the sensor support portion 135.

A plurality of pressing members 150 may be spaced apart from each other. Referring to FIG. 2, two pressing members 150 may be disposed to press a single sensor support portion 135. However, the disclosure is not limited to this example. For example, one pressing member 150 or three or more pressing members 150 may be configured to press the sensor support portion 135. In addition, a position at which the pressing member 150 presses the sensor support portion 135 may also be varied, if desired.

In addition, as described above, the pressing member 150 may be disposed to be in contact with the sensor support portion 135 in a region that does not oppose the force sensor 142.

When the pressing member 150 is disposed in a region opposing the force sensor 142, force applied by the pressing member 150 may be directly transferred to the force sensor 142 and, accordingly, the force sensor 142 may be deformed.

In addition, when the pressing member 150 is disposed in a region opposing the force sensor 142, and when there is a difference in elastic forces provided by each pressing member 150, respective spacing distances between the force sensors 142 and the pressing surface 12 may also be different from each other.

However, in the force sensing device 100, the pressing member 150 may be disposed to press a region corresponding to a peripheral region around the force sensor 142, rather than a region in which the force sensor 142 is disposed, such that a change in a shape of the force sensor 142 may be prevented, and respective distances between the force sensors 142 and the pressing surface 12 may be maintained to be constant.

However, the disclosure is not limited to the foregoing example, and when bending does not occur at all in the sensor support portion 135, even when the pressing force of the pressing member 150 is applied, the pressing member 150 may be disposed in a region opposing the force sensor 142.

When the pressing member 150 is disposed between the force sensor 142 and the frame 110 as in the embodiments disclosed herein, when a user press the pressing surface 12 (that is, the second sidewall), the pressing member 150 may be elastically deformed and compressed by the pressing force. In this process, the force sensor 142 and the support member 130 may move toward the first sidewall 14 side of the accommodation member 10 such that the distance between the support member 130 and the first sidewall 14 may be reduced.

Accordingly, the second sidewall 15 may be deformed within a relatively wide range as compared to the example in which no pressing member 150 is provided, and deformation of the pressed surface 12 may also be easily performed. Accordingly, overall displacement may increase such that sensing sensitivity may increase.

The spacing member 170 may be disposed between the frame coupling portion 134 of the support member 130 and the frame 110, and may allow the frame coupling portion 134 to be spaced apart from the frame 110 by a certain distance.

As shown in FIG. 4, the spacing member 170 may be formed in a spherical shape such as a ball, and a plurality of spacing members 170 may be disposed on a straight line, and may be in point-contact with the frame coupling portion 134 and the frame 110, respectively. To this end, the frame 110 and the support member 130 may include a first insertion portion 174 and a second insertion portion 172, respectively.

The first insertion portion 174 may be formed on the other surface of the frame coupling portion 134 opposing the frame 110, and may be formed in as a concave groove. The first insertion portion 174 may be formed in a shape in which a depth of a groove becomes greater toward a center of the first insertion portion 174. Accordingly, when the spacing member 170 is inserted into the first insertion portion 174 and is pressed to the support member 130 side, the spacing member 170 may be moved to the center of the first insertion portion 174.

Since only the spacing member 170 is disposed between the frame coupling portion 134 and the frame 110, if the spacing member 170 is disposed in a position skewed toward one side, the frame coupling portion 134 and the frame 110 may have different spacing distances from each other at different locations. For example, based on a center line P of FIG. 2, if only one spacing member 170 is disposed on an upper end portion (an upper portion) of the frame coupling portion 134, a lower end portion (a lower portion of the center line) of the frame coupling portion 134 may have a smaller spacing distance with the frame 110 compared to the upper end portion in which one the spacing member 170 is disposed.

Accordingly, the plurality of spacing members 170 may be disposed along the center line P of FIG. 2, which is a center of the frame coupling part 134 or the frame 110 in the width direction, and, accordingly, the center of the first insertion portion 174 may also be disposed on the center line P of the frame coupling portion 134 or the frame 110.

Here, the center line P is a virtual line bisecting the force sensing device 100 in the length direction of the force sensing device 100, and may be disposed on a plane bisecting the width of the frame 110 and the width of the support member 130.

The second insertion portion 172 is formed on the first surface of the frame 110 opposing the frame coupling portion 134, and may be formed in a form of a concave groove shape, similar to the shape of the first insertion portion 174. The second insertion portion 172 may be formed in the same size and shape as the first insertion portion 174, and may be formed in a position facing the first insertion portion 174. Therefore, when the spacing member 170 is inserted into the second insertion portion 172 and is pressed to the frame 110 side, the spacing member 170 may be moved to the center of the second insertion portion 172.

A portion of the spacing member 170 may be disposed in the first insertion portion 174, and some of the remaining portions of the spacing member 170 may be inserted into the second insertion portion 172.

The spacing member 170 may be configured to be in point-contact with each of the first insertion portion 174 and the second insertion portion 172. To this end, a radius of curvature inside the first and second insertion portions 174 and 172 may be formed to be greater than a radius of curvature of the surface of the spacing member 170.

One or a plurality of spacing members 170 may be provided, and the first and second insertion portions 174 and 172 may each be formed in a number corresponding to the number of the spacing members 170.

In addition, a portion in which the spacing member 170 contacts the support member 130 or the frame 110 may be disposed on the same plane as the portion in which the pressing member 150 contacts the support member 130. For example, the spacing member 170 and the pressing member 150 may be disposed to contact the support member 130 on the center line P described above.

When torsion occurs in the frame 110, the spacing member 170 is provided to minimize an effect of torsion being transmitted to the support member 130 and the sensor portion 140. For example, when external force is applied to the electronic device 1 and torsion occurs in the electronic device 1, the torsion of the electronic device 1 may also be transmitted to the frame 110, since the frame 110 is in close contact with the electronic device 1.

In this case, if the frame coupling portion 134 of the support member 130 is in surface-contact with the frame 110, torsion of the frame 110 may be transmitted to the support member 130, and, accordingly, torsion may also be transmitted to the support portion 140 since the support portion 140 is coupled to the support member 130. In this case, an unnecessary signal due to torsion may be input to the force sensor 142.

However, in the force sensing device 100, the support member 130 and the frame 110 are in contact only through the spacing member 170 and the pressing member 150. The spacing member 170 is configured to be in point-contact with the support member 130, and the pressing member 150 is configured to be in line-contact with the support member 130.

In addition, since a position in which the spacing member 170 contacts the support member 130 and a position in which the pressing member 150 contacts the support member 130 are both disposed on the center line P, the torsion of the frame 110 may be only slightly transmitted to the support member 130. That is, when torsion occurs in the frame 110, upper and lower ends of the frame 110 may have reduced spacing distances with the support member 130 by the torsion, but since the upper or lower ends of the frame 110 do not directly contact the support member 130, the transmission of this torsion of the frame 110 to the support member 130 may be suppressed.

Accordingly, when torsion occurs in the electronic device, it is possible to minimize an unnecessary signal input to the force sensor 142.

The force sensing device 100 may include at least one physical button 180.

The physical button 180 may be disposed on one side of the frame coupling portion 134, and may be used as a different input device distinguished from the force sensor 142.

The physical button 180 may be, for example, a mechanically operating push button. However, this example is not limiting. Various devices, such as an input device using a wheel, may be implemented as the physical button 180, as long as various signals input from an external entity are detected.

The physical button 180 may penetrate the second sidewall 15 and may be exposed externally of a case of the electronic device. Accordingly, a user may control the physical button 180 by directly contacting the physical button 180. However, the physical button 180 is not limited to such an example, and the physical button 180 may be configured to be disposed in the accommodation member 10.

The physical button 180 may be disposed in a portion of the connection portion 145 that is coupled to the frame coupling portion 134 and mounted on the connection portion 145. In addition, a thickness of the physical button 180 may be thicker than that of the force sensor 142. Accordingly, in the sensor portion 140, the thickness of the portion on which the physical button 180 is mounted may be greater than the thickness of the portion on which the force sensor 142 is mounted.

Since a signal is input to the physical button 180 by physical and mechanical operations, unnecessary signals are not input due to the torsion of the frame 110.

Since the spacing member 170 is not elastically connected to the support member 160 like the pressing member 150, when torsion occurs in the frame 110, the frame coupling portion 134, which is coupled to the spacing member 170, may be most affected by the torsion.

Therefore, in the force sensing device 100, the physical button 180 may be coupled to the frame coupling portion 134. Accordingly, an influence applied to the force sensor 142 due to the torsion of the frame 110 may be minimized.

The force sensing device 100 is not limited to the above-described embodiment, and various applications are possible.

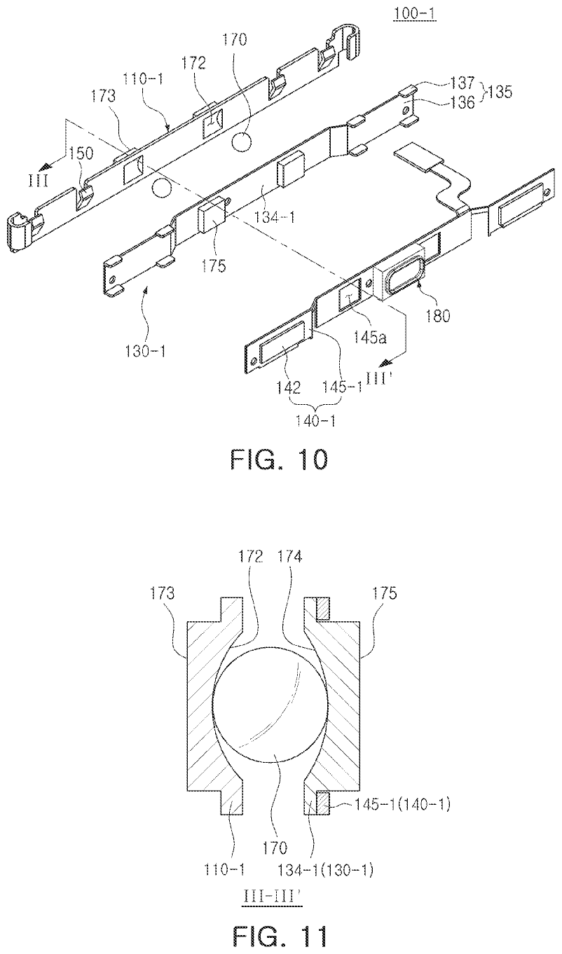

FIG. 10 is an exploded perspective view illustrating a force sensing device 100-1, according to another embodiment. FIG. 11 is a cross-sectional view of the force sensing device illustrated in FIG. 10, showing a cross-section corresponding to the cross-section taken along line I-I′ of FIG. 3.

Referring to FIGS. 10 to 11, the force sensing device 100-1 includes a first protruding portion 175 protruding from a region, corresponding to the first insertion portion 174, of one surface of a support member 130-1 on which a sensor portion 140-1 is disposed. A second protruding portion 173 protrudes from a region, corresponding to the second insertion portion 172, of a second surface of a frame 110-1.

Since the first protruding portion 175 and the second protruding portion 173 are provided in the force sensing device 100-1, the size and depth of the first and second insertion portions 174 and 172 may be expanded in comparison to the previously described embodiments, and, thus, the size of the spacing member 170 may also be increased.

When the size (e.g., a diameter) of the spacing member 170 is increased, a spacing distance between a frame coupling portion 134-1 of the support member 130-1 and the frame 110-1 may be increased.

When an interval between the frame coupling portion 134-1 of the support member 130-1 and the frame 110-1 is excessively narrow, when torsion occurs in the frame 110-1, a portion of the frame 110-1 may be in contact with the support member 130-1. However, in the force sensing device 100-1, since a sufficient spacing distance between the frame coupling portion 134-1 of the support member 130-1 and the frame 110-1 is secured, the problem of the frame 110-1 coming in contact with the support member 130-1 due to torsion occurring in the frame 110-1 can be solved.

Since the first protruding portion 175 is provided, a portion 145a of a connection portion 145-1 corresponding to the first protruding portion 175 may be removed. Thus, the portion 145a may be an opening in a position corresponding to the first protruding portion 175. In addition, since the second protruding portion 173 is provided, a groove into which the second protruding portion 173 is inserted may be provided in a first sidewall (e.g., the first sidewall 14 in FIGS. 8 and 9) of an electronic device.

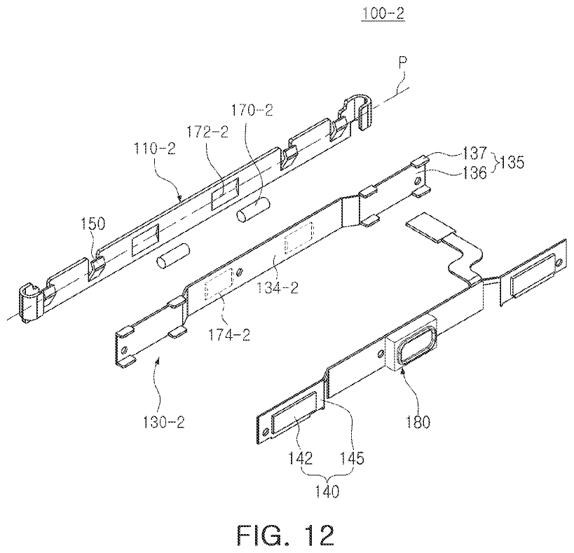

FIG. 12 is an exploded perspective view illustrating a force sensing device 100-2, according to another embodiment.

Referring to FIG. 12, in the force sensing device 100-2, a spacing member 170-2 may be formed in a cylindrical roller shape rather than a spherical shape. First and second insertion portions 174-2 and 172-2 of a support member 130-2 and a frame 110-2, respectively, may be elongated in a length direction of the support member 130-2 and the frame 110-2, respectively, to accommodate the spacing member 170-2.

Accordingly, the spacing member 170-2 may be in line-contact with the frame 110-2 and a frame coupling portion 134-2 of the support member 130-2, instead of being in point-contact therewith.

Like the embodiment of FIGS. 10 and 11, the spacing member 170-2 may be disposed to be in line-contact with the support member 130-2 and the frame 110-2 on the center line P. Therefore, even if torsion occurs in the frame 110-2, it is possible to suppress transmission of the torsion to the support member 130-2. At the same time, since the support member 130-2 and the frame 110-2 are in contact with a wider portion of the spacing member 170-2, the support member 130-2 and the frame 110-2 may be more stably connected.

As set forth above, according to embodiments disclosed herein, a force sensing device may minimize an unnecessary signal input to a force sensor when torsion occurs in an electronic device in which the force sensor is mounted.

While example embodiments have been shown and described above, modifications and variations may be made without departing from the scope of the disclosure.

For example, in the above-described embodiments, a case in which the pressing member is integrally formed with the frame has been described, but the pressing member may be integrally formed with the support member if necessary.

In addition, in the above-described embodiments, a case in which a support protrusion protrudes from the sensor support portion is described, but various modifications are possible, such as the support protrusion protruding from the accommodation member or being configured as an independent, separate member, if necessary.

In addition, each of the embodiments described herein can be combined with each other.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A force sensing device, comprising:
a support member including:
a sensor support portion to which a force sensor is coupled on one surface of the support member; and
a frame coupling portion extending from the sensor support portion;
a frame facing another surface of the support member, and disposed to be spaced apart from the support member; and
at least one spacing member disposed between the support member and the frame and spacing the support member apart from the frame,
wherein the force sensor is not disposed in the frame coupling portion, and
wherein the spacing member is disposed between the frame coupling portion and the frame.

2. The force sensing device of claim 1, wherein the a least one spacing member has a spherical shape or a cylindrical shape.

3. The force sensing device of claim 2, wherein the frame includes at least one insertion portion disposed on one surface of the frame, and the at least one spacing member is disposed in the at least one insertion portion.

4. The force sensing device of claim 3, wherein the at least one insertion portion is formed as a concave groove having an inner radius of curvature that is greater than a radius of curvature of a surface of the at least one spacing member.

5. The force sensing device of claim 3, wherein the frame includes at least one protruding portion protruding from another surface of the frame in a region corresponding to the at least one insertion portion.

6. The force sensing device of claim 2, wherein the support member includes at least one insertion portion disposed on another surface of the support member, and the at least one spacing member is disposed in the at least one insertion portion.

7. The force sensing device of claim 6, wherein the at least one insertion portion comprises a concave groove having an inner radius of curvature that is greater than a radius of curvature of a surface of the at least one spacing member.

8. The force sensing device of claim 6, wherein the frame coupling portion includes at least one protruding portion protruding from the one surface of the frame in a region corresponding to the at least one insertion portion.

9. The force sensing device of claim 2, wherein the at least one spacing member comprises a plurality of spacing members disposed on a straight line.

10. The force sensing device of claim 1, wherein the at least one spacing member is disposed to contact the support member on a center line bisecting the support member along a length direction of the support member.

11. The force sensing device of claim 1, wherein the spacing member is in point-contact or line-contact with the support member and the frame.

12. The force sensing device of claim 1, further comprising a pressing member disposed between the sensor support portion and the frame, and configured to press the sensor support portion.

13. The force sensing device of claim 12, wherein the pressing member and the support member are in contact with each other in a portion disposed on a same plane as a portion in which the at least one spacing member contacts the support member.

14. The force sensing device of claim 13, wherein a spacing distance between the sensor support portion and the frame is different from a spacing distance between the frame coupling portion and the frame.

15. The force sensing device of claim 12, wherein the pressing member protrudes from the frame in a cantilever form.

16. The force sensing device of claim 12, wherein a surface of the pressing member that is in contact with the sensor support portion is a curved surface.

17. An electronic device, comprising:
an accommodation member including a first sidewall and a second sidewall, the second sidewall being disposed opposite the first sidewall and configured to be deformed by external force; and
a force sensing device disposed in the accommodation member, and including:
a frame disposed in contact with a first sidewall;
a support member spaced apart from the frame, at least a portion of the support member being in contact with the second sidewall;
at least one force sensor coupled to the support member and opposing the second sidewall; and
a plurality of spacing members disposed between the support member and the frame, and disposed in contact with the support member on a center line bisecting the support member in a length direction of the support member.

18. The electronic device of claim 17, wherein the plurality of spacing members are disposed between a central portion of the support member, with respect to the length direction, and the frame, and
wherein the force sensor is coupled to an end portion of the support member, with respect to the length direction.

19. The electronic device of claim 17, further comprising a plurality of pressing members extending from the frame and configured to press the support member to the second sidewall,
wherein the plurality of pressing members are in contact with the support member on the center line.

20. A force sensing device, comprising:
a support member including a sensor support portion disposed in an outer portion of the support member, with respect to a length direction of the support member;
a force sensor mounted on a first surface of the support member, in the sensor support portion;
a frame opposing a second surface of the support member; and
a plurality of spacing members disposed between the frame and a central portion of the support member, with respect to the length direction, and spacing the support member and the frame apart from each other.

21. The force sensing device of claim 20, wherein the plurality of spacing members have a spherical shape or a cylindrical shape, and are in contact with the support member on a center line that bisects the support member in the length direction.

22. The force sensing device of claim 21, further comprising a plurality of spring members extending from the frame and configured to press the support member,
wherein the plurality of spring members are in contact with the support member on the center line.
